(19) United States
(12) Patent Application Publication
(10) Pub. No.: US 2012/0252942 A1
(43) Pub. Date: Oct. 4, 2012

(54) AQUEOUS INK COMPOSITION

(75) Inventors: Katsuko AOKI, Kiso (JP); Hiroshi MUKAI, Shiojiri (JP)

(73) Assignee: SEIKO EPSON CORPORATION, Tokyo (JP)

(21) Appl. No.: 13/434,097

(22) Filed: Mar. 29, 2012

(30) Foreign Application Priority Data
Apr. 1, 2011 (JP) 2011-081678

(51) Int. Cl. C09D 11/12; C09D 11/10

(52) U.S. Cl. 524/104; 106/31.13; 524/476

(57) ABSTRACT

An aqueous ink composition includes at least one kind of water-insoluble colorant and a wax in which the wax is a paraffin wax with a melting point of 60° C. to 110° C. and an average particle size of 30 nm to 250 nm.

Priority is claimed under 35 U.S.C. §119 to Japanese Application No. 2011-081678 filed on Apr. 1, 2011, which is hereby incorporated by reference in its entirety.

### BACKGROUND

1. Technical Field

The present invention relates to an aqueous ink composition.

2. Related Art

In an ink jet recording method, printing is performed by causing small droplets of ink to fly and attach to a recording medium such as a sheet. Recent innovative advances in ink jet recording methods have led to the use thereof even in the field of high-definition image recording (image printing) which have been performed for photo or offset printing. Therefore, high-quality printed matter is required not only for a generally used plain paper and a sheet for ink jet recording (matte paper or glossy paper) but also for a non-ink-absorbent or low-ink-absorbent recording medium such as a book printing paper, a synthetic paper, or a film.

Recently, an ink composition has been discussed which can perform recording on, in addition to the plain paper and the sheet for ink jet recording described above, a film recording medium such as a book printing paper or a polyvinyl chloride substrate, that is, the non-ink-absorbent recording medium. Instead of a solvent pigment ink used for the non-ink-absorbent recording medium, aqueous ink is used from the viewpoint of safety and environmental protection. A method in which printing is performed on a hydrophobic surface using, as an example of the aqueous ink, ink containing water, glycol solvents, insoluble colorants, polymer dispersants, silicone surfactants, fluorosurfactants, water-insoluble graft copolymer binders, and N-methylpyrrolidone, is disclosed (refer to JP-A-2000-44858). Furthermore, in order to perform printing on a nonporous substrate which includes aqueous liquid vehicles containing volatile cosolvents with a boiling point of 285° C. or lower, acid-functionalized polymer colloid particles, and pigment colorants, an aqueous ink containing polymer colloid for ink jet printing is disclosed (refer to JP-A-2005-220352). In addition, a heat-fixing ink in which organic solvents having a specific parameter of solubility are used to prevent unevenness, is disclosed (refer to JP-A-2008-260820).

However, the aqueous ink disclosed in the related art is insufficient in terms of printing quality and abrasion-resistance of an image formed on a recording medium. Therefore, further improvement of these characteristics is required for the ink composition. Specifically, a phenomenon of color mixing or spreading, which exceeds a predetermined range, between different colors (hereinafter, referred to as “blurring”) or a phenomenon where ink is thick or thin in a filled image, that is, that the thickness of ink is uneven, (hereinafter referred to as “uneven thickness”) occurs. Therefore, the ink composition in the related art does not exhibit a desired printing quality. In addition, when printed matter using the ink composition in the related art comes into contact with an object and is rubbed, a printing surface is scraped off or peeled off from the recording medium in many cases. As a result, practical abrasion-resistance is required. Although wax is also discussed, there are problems with an anti-clogging property, storage stability, and ink uniformity.

### SUMMARY

An advantage of some aspects of the invention is to provide an aqueous ink composition which can record a favorable image onto various recording media and has an excellent anti-clogging property, storage stability, and ink uniformity.

The invention is as follows.

(1) An aqueous ink composition including: at least one kind of water-insoluble colorant; and a wax, wherein the wax is a paraffin wax with a melting point of 60° C. to 110° C. and an average particle size of 30 nm to 250 nm.

(2) The ink composition according to (1) described above, wherein the content of the paraffin wax is 0.1% by mass to 3% by mass.

(3) The ink composition according to (1) or (2) described above, wherein the average particle size of the paraffin wax is 50 nm to 200 nm.

(4) The ink composition according to any one of (1) to (3) described above, wherein the melting point of the paraffin wax is 65° C. to 100° C.

(5) The ink composition according to any one of (1) to (4) described above, wherein an alkylpolyol with a boiling point of 280° C. or higher under one atmosphere is not included in practice.

(6) The ink composition according to any one of (1) to (5) described above, further including resin particles, wherein the total content of the resin particles and the wax is 1% by mass to 5.5% by mass.

(7) The ink composition according to any one of (1) to (6) described above, further including a 1,2-alkyldiol having 5 to 7 carbon atoms, resin particles, nonionic surfactants, and pyrrolidone derivatives.

(8) The ink composition according to any one of (1) to (7) described above, wherein the ink composition is discharged from a discharge head through a nozzle having the diameter of 10 μm to 30 μm.

(9) The ink composition according to any one of (1) to (8) described above, wherein the ink composition is discharged from a discharge head having a piezoelectric element.

(10) The ink composition according to any one of (1) to (9) described above, wherein the ink composition is discharged onto a recording medium which is heated by a heating mechanism.

### DESCRIPTION OF EXEMPLARY EMBODIMENTS

An aqueous ink composition according to an aspect of the invention contains a paraffin wax with a melting point of 60° C. to 110° C. and an average particle size in terms of volume (hereinafter, referred to as “average particle size”) of 30 nm to 250 nm, preferably, 50 nm to 200 nm.

Hereinafter, a preferred embodiment according to the invention will be described in detail.

### 1. Aqueous Ink Composition

The aqueous ink composition according to the invention includes at least a water-insoluble colorant and a paraffin wax with a melting point of 60° C. to 110° C. and an average particle size of 30 nm to 250 nm, preferably 50 nm to 200 nm. In addition, the aqueous ink composition according to the invention may further include components other than the above-described components, and preferably include a 1,2-alkyldiol having 5 to 7 carbon atoms, resin particles, nonionic surfactants, pyrrolidone derivatives, and waxes other than the paraffin wax.

Hereinafter, these components will be described in detail.

### 1.1 Colorant

The aqueous ink composition according to the invention contains a water-insoluble colorant.

The water-insoluble colorant is preferably a pigment and desirably a solution in which water-soluble resin is dispersed in ink. The pigment is insoluble or practically-insoluble in water and has characteristics that color mixing rarely occurs due to light, gas, or the like. Therefore, printed matter printed by an ink composition using the pigment has excellent water-resistance, gas-resistance, light-resistance, and storability. As the pigment, any one of known inorganic pigments, known organic pigments, and known carbon blacks can be used. Among these, the carbon blacks and the organic pigments are preferable from the viewpoint that they exhibit favorable coloring and are hardly precipitated during dispersion because of low specific gravity.

Preferable examples of the carbon blacks include Furnace black, Lamp black, Acetylene black, Channel black, and the like (C.I. pigment black 7), and include, as commercially available products, No. 2300, 900, MCF88, No. 20B, No. 33, No. 40, No. 45, No. 52, MA7, MA8, MA100, No. 2200B, and the like (trade names; manufactured by Mitsubishi Chemical Corporation), CARBON BLACK FW1, FW2, FW2V, FW18, FW200, 5150, S160, 5170, PRETEX 35, U, V, 140U, SPECIAL BLACK 6, 5, 4A, 4, 250, and the like (trade names; manufactured by Degussa AG.), CONDUCTEX SC, RAVEN 1255, 5750, 5250, 5000, 3500, 1255, 700, and the like (trade names; manufactured by Columbia Carbon Co., Ltd.), and REGAL 400R, 330R, 660R, MOGUL L, MONARCH 700, 800, 880, 900, 1000, 1100, 1300, 1400, ELFTEX 12, and the like (trade names; manufactured by Cabot Corporation).

In addition, the above-described preferable carbon blacks according to the invention are merely examples, and the invention is not limited thereto.

These carbon blacks may be used alone or in a mixture of two or more kinds. The content of the carbon black is 0.1% by mass to 20% by mass and preferably 0.5% by mass to 10% by mass, with respect to the total content of black ink composition.

Preferable examples of the organic pigments according to the invention include quinacridone pigments, quinacridonequinone pigments, dioxazine pigments, phthalocyanine pigments, anthrapyrimidine pigments, anthanthrone pigments, indanthrone pigments, flavanthrone pigments, perylene pigments, diketo-pyrrolo-pyrrole pigments, perinone pigments, quinophthalone pigments, anthraquinone pigments, thioindigo pigments, benzimidazolone pigments, isoindolinone pigments, azomethine pigments, and azo pigments.

Specific examples of the organic pigments used in the aqueous ink composition according to the invention are as follows.

Examples of a pigment used in a cyan ink composition include C.I. pigment BLUE 1, 2, 3, 15:3, 15:4, 15:34, 16, 22, 60, and C.I. VAT BLUE 4, 60. The pigment is preferably used alone or in a mixture of two or more kinds selected from a group consisting of C.I. pigment BLUE 15:3, 15:4, and 60.

In addition, the content of the pigment is 0.1% by mass to 20% by mass and preferably 0.5% by mass to 10% by mass, with respect to the total content of cyan ink composition.

Examples of a pigment used in a magenta ink composition include C.I. pigment RED 5, 7, 12, 48(Ca), 48 (Mn), 57(Ca), 57:1, 112, 122, 123, 168, 184, 202, 209, and C.I. pigment VIOLET 19. The pigment is preferably used alone or in a mixture of two or more kinds selected from a group consisting of C.I. pigment RED 122, 202, 209, and C.I. pigment VIOLET 19. In addition, the content of the pigment is 0.1% by mass to 20% by mass and preferably 0.5% by mass to 10% by mass, with respect to the total content of magenta ink composition.

Examples of a pigment used in a yellow ink composition include C.I. pigment YELLOW 1, 2, 3, 12, 13, 14C, 16, 17, 73, 74, 75, 83, 93, 95, 97, 98, 109, 110, 114, 128, 129, 138, 150, 151, 154, 155, 180, 185, 213. The pigment is preferably used alone or in a mixture of two or more kinds selected from a group consisting of C.I. pigment YELLOW 74, 155, 180, 213.

In addition, the content of the pigment is 0.1% by mass to 20% by mass and preferably 0.5% by mass to 10% by mass, with respect to the total content of yellow ink composition.

In order to apply the above-described pigments to the aqueous ink composition, it is necessary that the pigments be stably stored in a state of being dispersed in water.

Examples of the methods thereof include a method of dispersing the pigment using a water-soluble resin and/or a resin dispersant such as a water-dispersible resin (hereinafter, the pigment subjected to this method is referred to as “a resin dispersion pigment”), a method of dispersing the pigment using a water-soluble surfactant and/or a water-dispersible surfactant (hereinafter, the pigment subjected to this method is referred to as “a surfactant dispersion pigment”), and a method of chemically and physically introducing a hydrophilic functional group into the surface of pigment particles without the dispersant such as the resin or the surfactant described above and allowing the pigment to be dispersed and/or dissolved in water (hereinafter, the pigment subjected to this method is referred to as “a surface treatment pigment”).

The aqueous ink composition according to the invention can use the above-described resin dispersion pigment, surfactant dispersion pigment, and surface treatment pigment, and optionally use a mixture of plural kinds. In particular, the resin dispersion pigment is preferable from the viewpoint that, when aqueous ink recorded matter is attached on a recording medium, the adhesion between the recording medium, the ink composition, and/or solid matter in the ink composition is increased. In addition, the surface treatment pigment is preferable from the viewpoint that the dispersion stability of the pigment is increased and the storage stability of the aqueous ink composition is favorable.

Examples of the resin dispersant used for the surfactant dispersion pigment include polyvinyl alcohols, polyacrylic acids, acrylic acid-acrylonitrile copolymers, vinyl acetate-acrylate copolymers, acrylic acid-acrylate copolymers, styrene-acrylic acid copolymers, styrene-methacrylic acid copolymers, styrene-methacrylic acid-acrylate copolymers, styrene-α-methylstyrene-acrylic acid copolymers, styrene-α-methylstyrene-acrylic acid-acrylate copolymers, styrene-maleic acid copolymers, styrene-maleic anhydride copolymers, vinylnaphthalene-acrylic acid copolymers, vinylnaphthalene-maleic acid copolymers, vinyl acetate-maleate copolymers, vinyl acetate-crotonic acid copolymers, and vinyl acetate-acrylic acid copolymers, and the salts thereof.

Among these, copolymers of monomers having a hydrophobic functional group and monomers having a hydrophilic functional group and copolymers of monomers having a hydrophobic functional group and a hydrophilic functional group are particularly preferable.

The copolymers can be used in any forms of random copolymer, block copolymer, alternating copolymer, and graft copolymer.

Examples of the salts include salts of a basic compound such as ammonia, ethylamine, diethylamine, triethylamine, propylamine, isopropylamine, dipropylamine, butylamine, isobutylamine, diethanolamine, triethanolamine, triisopropanolamine, amino methyl propanol, and morpholine.

The amount of the basic compound added is not particularly limited as long as the resin dispersant is equal to or more than the neutralization equivalent.

The molecular weight of the resin dispersant is 1000 to 100000 and preferably 3000 to 10000, in terms of weight-average molecular weight.

When the molecular weight is in the above-described range, the colorant is stably dispersed in water and the viscosity is easily controlled at the time of application to the aqueous ink composition.

In addition, the acid value thereof is preferably in the range of 50 to 300 and more preferably in the range of 70 to 150.

When the acid value is in this range, the stable dispersibility of color particles in water is secured. The water-resistance of printed matter, which is printed by the aqueous ink composition based on this, is favorable.

As the above-described resin dispersant, the commercially available products can also be used.

Specific examples thereof include JONCRYL 67 (weight-average molecular weight: 12,500, acid value: 213), JONCRYL 678 (weight-average molecular weight: 8,500, acid value: 215), JONCRYL 586 (weight-average molecular weight: 4,600, acid value: 108), JONCRYL 611 (weight-average molecular weight: 8,100, acid value: 53), JONCRYL 680 (weight-average molecular weight: 4,900, acid value: 215), JONCRYL 682 (weight-average molecular weight: 1,700, acid value: 238), JONCRYL 683 (weight-average molecular weight: 8,000, acid value: 160), JONCRYL 690 (weight-average molecular weight: 16,500, acid value: 240) (trade names; manufactured by BASF Japan Ltd.).

In addition, examples of the surfactant used for the surfactant dispersion pigment include anionic surfactants such as alkanesulfonates, α-olefin sulfonates, alkylbenzene sulfonates, alkylnaphthalene sulfonates, acyl methyl taurinates, dialkyl sulfosuccinates, alkyl sulfates, sulfurized olefins, polyoxyethylene alkyl ether sulfates, alkyl phosphates, polyoxyethylene alkyl ether phosphates, and monoglyceride phosphate, amphoteric surfactants such as alkylpyridinium salts, alkylamino acid salts, and alkyl dimethyl betaine, and nonionic surfactants such as polyoxyethylene alkyl ethers, polyoxyethylene alkyl phenyl ethers, polyoxyethylene alkyl esters, polyoxyethylene alkyl amides, glycerol alkyl esters, and sorbitan alkyl esters.

The amount of the resin dispersant or the surfactant added with respect to the pigment is preferably 1 part by mass to 100 parts by mass and more preferably 5 parts by mass to 50 parts by mass, with respect to 100 parts by mass of pigments. In this range, the dispersion stability of the pigment in water is secured.

In addition, examples of the hydrophilic functional group in the surface treatment pigment include —OM, —COOM, —CO—, —SO₃M, —SO₂NH₂, —RSO₂M, —PO₃HM, —PO₃M₂, —SO₂NHCOR, —NH₃, and —NR₃ (where, M in the expression represents a hydrogen atom, an alkali metal, ammonium, or organic ammonium; and R represent an alkyl group having 1 to 12 carbon atoms, a phenyl group which may have a substituent, or a naphthyl group which may have a substituent).

These functional groups are physically and/or chemically introduced by being grafted on the surface of pigment particles directly and/or through a polyvalent group.

Examples of the polyvalent group include an alkylene group having 1 to 12 carbon atoms, a phenyl group which may have a substituent, and a naphthyl group which may have a substituent.

In addition, it is preferable in the surface treatment pigment that the surface of the pigment particles is treated by a sulfur-containing treating agent such that —SO₃M and/or —RSO₂M is chemically bonded (M represents a hydrogen ion, an alkali metal ion, an ammonium ion or an organic ammonium ion, as a counter ion). That is, it is preferable that the pigment does not have an active proton and reactivity with a sulfonic acid; the pigment be dispersed in a solvent where the pigment is insoluble or practically-insoluble; the surface of particles be treated by an amidesulfuric acid and a complex of sulfur trioxide and a tertiary amine such that —SO₃M and/or —RSO₂M is chemically bonded; and thus the pigment be allowed to be dispersed and/or dissolved in water.

The functional group grafted on each pigment particle may be one or plural kinds.

The kinds of the grafted functional group and the amounts thereof are appropriately determined in consideration of dispersion stability and color density in ink, a drying property in the front surface of an ink jet head, and the like.

In the methods of dispersing the above-described resin dispersion pigment, surfactant dispersion pigment, and surface treatment pigment into water, the pigment, water, and the resin dispersant are applied in the case of a resin dispersion pigment, the pigment, water, and the surfactant are applied in the case of a surfactant dispersion pigment, and the surface treating agent and water are applied in the case of a surface treatment pigment. Optionally, water-soluble organic solvent or neutralizer is applied thereto, respectively. Then, dispersion can be performed by known dispersers in the related art, such as a ball mill, a sand mill, an attritor, a roll mill, an agitator mill, a Henschel mixer, a colloid mill, an ultrasonic homogenizer, a jet mill, an ANGMILL, and the like.

In this case, the pigment is dispersed until the average particle size is preferably in the range of 20 nm to 500 nm and more preferably in the range of 50 nm to 200 nm, from the viewpoint of securing the dispersion stability of the pigment in water.

### 1.2 Water

The aqueous ink composition according to the invention contains water.

Water is a main medium of the aqueous ink composition and a component which is evaporated and scattered in a second process (drying process) described below. Water such as pure water or ultrapure water of ion exchange water, ultrafiltration water, Milli Q water, distilled water and the like in which ionic impurities are removed as much as possible is preferable. In addition, since fungi and bacteria are prevented from occurring, water sterilized by ultraviolet irradiation or hydrogen peroxide addition is preferable in a case where a pigment dispersion liquid or the aqueous ink composition using the pigment dispersion liquid is stored over a long period of time. In addition, the content of the water is not particularly limited but is preferably equal to or more than 50% by mass.

### 1.3 Wax

### 1.3.1 Paraffin Wax

The aqueous ink composition according to the invention essentially contains a paraffin wax. The paraffin wax is a so-called petroleum wax, has a linear paraffin hydrocarbon having 20 to 30 carbon atoms (normal paraffin) as a main component, and is a mixture of hydrocarbons which contains a small amount of isoparaffin and has a molecular weight of 300 to 500. The ink composition has an excellent fixing and solidification property as well as an excellent anti-clogging property (discharge stability) by containing the paraffin wax. In addition, when plural kinds of waxes are added to the ink composition, “wax” in the invention represents all of the waxes.

In addition, the paraffin wax according to the invention has a melting point of 60° C. to 110° C. and an average particle size of 30 nm to 250 nm. Preferably, slip characteristics are imparted to recorded matter by blending the paraffin wax having the average particle size of 50 nm to 200 nm, thereby improving abrasion-resistance. In addition, since the paraffin wax is water-repellent, an appropriate amount of paraffin wax can improve the water-resistance of recorded matter. Preferably, the melting point of paraffin wax is 65° C. to 100° C. When the melting point of paraffin wax is lower than 60° C., a recording surface is sticky without being dried. On the other hand, when the melting point of paraffin wax is higher than 110° C., the paraffin wax is solidified and an ink jet recording head is easily clogged. Furthermore, when the average particle size is less than 30 nm, the dispersion of the paraffin wax in ink becomes unstable. As a result, ink is thickened and the storage stability falls below a practical level. When the average particle size is higher than 250 nm, the uniform dispersion in ink is difficult.

According to the invention, the paraffin wax is included preferably in a fine particle state (that is, in an emulsion state or suspension state). By containing the paraffin wax in the particle state, the viscosity of the aqueous ink composition is easily adjusted to be in an appropriate range in the ink jet recording method and the storage stability and discharge stability are easily secured.

The content of the paraffin wax is, in terms of the solid content, 0.1% by mass to 3% by mass, more preferably 0.1% by mass to 1.5% by mass, and further preferably 0.5% by mass to 1.5% by mass, with respect to the total content of aqueous ink composition.

1.3.2 Waxes Other than Paraffin Wax

The aqueous ink composition according to the invention contains waxes other than the paraffin wax. Similar to the paraffin wax, the waxes other than the paraffin wax have the functions of imparting a slipping property to the surface of printed matter and improving water-resistance. The waxes other than the paraffin wax are included in the aqueous ink composition preferably in a fine particle state (that is, in an emulsion state or suspension state). Due to this, the viscosity of the aqueous ink composition is easily adjusted to be in an appropriate range in the ink jet recording method and the storage stability and discharge stability are easily secured.

Examples of components of the waxes other than the paraffin wax include plant and animal waxes such as carnauba wax, candelilla wax, beeswax, rice bran wax, and lanolin; petroleum waxes such as microcrystalline wax, polyethylene wax, oxidized polyethylene wax, and petrolatum; mineral waxes such as montan wax and ozokerite; synthetic waxes such as carbon wax, Hoechst wax, polyolefin wax, and stearic acid amide; natural or synthetic wax emulsions such as α-olefin-maleic anhydride copolymer; and blend waxes. The waxes other than the paraffin wax are used alone or in a mixture of plural kinds. Among these, polyolefin waxes are preferable. Polyethylene wax and polypropylene wax are preferable and polyethylene wax is most preferable.

In addition, commercially available products are used without any modification, and examples thereof include NOPCOAT PEM-17 (trade name; manufactured by SAN NOPCO LIMITED), CHEMIPEARL W-4005 (trade name; manufactured by Mitsui Chemicals, Inc.), AQUACER515, AQUACER593 (trade names; manufactured by BYK Japan KK). The average particle size of the waxes other than the paraffin wax is preferably 5 nm to 400 nm and more preferably 50 nm to 200 nm, from the viewpoint of securing the storage stability and discharge stability of the aqueous ink composition.

The content of the waxes other than the paraffin wax, in terms of the solid content, is preferably equal to or less than 5% by mass and more preferably 0.1% by mass to 1% by mass, with respect to the total content of the aqueous ink composition. In the above-described range, a fixing and solidification property is favorable even on a non-ink-absorbent or low-ink-absorbent recording medium. In addition, preferably, by adding a heating process described below to the ink jet recording method, the aqueous ink composition can be solidified and fixed more favorably.

### 1.4 Other Preferable Components

1.4.1 1,2-Alkyldiols having 5 to 7 Carbon Atoms

The aqueous ink composition according to the invention may contain 1,2-alkyldiols having 5 to 7 carbon atoms (hereinafter, sometimes referred to as C5 to C7 1,2-alkyldiols). The C5 to C7 1,2-alkyldiols are further preferable in combination with a non-ink-absorbent recording medium such as plastic, film, and glass which are heated by a heating mechanism.

The C5 to C7 1,2-alkyldiols have the effects of further improving the wettability of the aqueous ink composition to wet the recording medium more uniformly and further improving the permeability. Therefore, when the aqueous ink composition contains the C5 to C7 1,2-alkyldiols, the uneven thickness and the blurring of ink can be reduced.

Specific examples of the C5 to C7 1,2-alkyldiols include 1,2-pentanediol, 1,2-hexanediol, 1,2-heptanediol, and 4-methyl-1,2-pentanediol.

The amount of the C5 to C7 1,2-alkyldiols added is preferably 0.5% by mass to 20% by mass and more preferably 1% by mass to 8% by mass with respect to the total content of the aqueous ink composition, from the viewpoint of securing the storage stability and discharge stability of the aqueous ink composition. When the content of the C5 to C7 1,2-alkyldiols is less than 0.5% by mass, the wettability of the aqueous ink composition to the recording medium deteriorates and uneven thickness and blurring may occur on the printed matter. In addition, when the content is more than 20% by mass, in the ink jet recording method, it is difficult to set the viscosity of the aqueous ink composition in an appropriate range. As a result, the discharge is unstable and the storage stability of the aqueous ink composition over a long period of time may be secured with difficulty. When the content is in the more preferable range of 1% by mass to 8% by mass, the evaporating and scattering rate of C5 to C7 1,2-alkyldiols increases through the heating process described below of the ink jet recording method according to the invention. As a result, the printed matter is rapidly dried, thereby exhibiting an excellent effect of improving the printing speed. In addition, problems with odor do not occur during the printing process.

### 1.4.2 Resin Particles

The aqueous ink composition according to the invention preferably contains resin particles. Here, the resin particles do not contain the above-described waxes. In addition, as the resin particles, thermoplastic resins are preferably used.

When the aqueous ink composition contains the resin particles, images with excellent abrasion-resistance can be formed on the recording medium. In particular, when printing is performed using the aqueous ink composition containing the resin particles on a non-ink-absorbent or low-ink-absorbent recording medium such as vinyl chloride film, polypropylene film, or polyethylene terephthalate, images with further excellent abrasion-resistance can be obtained in combination with the heating process of the ink jet recording method according to the invention. In addition, the recording medium is not limited to the non-ink-absorbent or low-ink-absorbent recording medium.

The reason thereof is that the resin particles have the action of solidifying ink and fixing the solidified ink onto the recording medium during the heating process described below of the ink jet recording method according to the invention. Therefore, heating enhances this action. In particular, the aqueous ink composition according to the invention preferably contains the resin particles in a fine particle state (that is, in an emulsion state or suspension state). When the resin particles are included in the fine particle state, the viscosity of the aqueous ink composition is easily adjusted to be in an appropriate range in the ink jet recording method and the storage stability and discharge stability are easily secured. Hereinafter, the resin particles will be described in detail.

Examples of components of the resin particles include homopolymers or copolymers of acrylic acid, acrylate, methacrylic acid, methacrylate, acrylonitrile, cyanoacrylate, acrylamide, olefin, styrene, vinyl acetate, vinyl chloride, vinyl alcohol, vinyl ether, vinylpyrrolidone, vinylpyridine, vinylcarbazole, vinylimidazole, and vinylidene chloride; fluororesin; and natural resin. In addition, the copolymers can be used in any form of random copolymer, block copolymer, alternating copolymer, and graft copolymer. Preferable examples of the resin articles include acrylic resin or styrene-acrylic acid copolymer resin.

In addition, commercially available products can be also used, and examples thereof include MICROGEL E-1002, MICROGEL E-5002 (trade names; manufactured by NIPPON PAINT Co., Ltd.), VONCOAT 4001, VONCOAT 5454 (trade names; manufactured by DIC Corporation), SAE1014 (trade name; manufactured by ZEON CORPORATION), SAIVINOL SK-200 (trade name; manufactured by Saiden Chemical Industry Co., Ltd.), and JONCRYL 7100, JONCRYL 390, JONCRYL 711, JONCRYL 511, JONCRYL 7001, JONCRYL 632, JONCRYL 741, JONCRYL 450, JONCRYL 840, JONCRYL 74J, JONCRYL HRC-1645J, JONCRYL 734, JONCRYL 852, JONCRYL 7600, JONCRYL 775, JONCRYL 537J, JONCRYL 1535, JONCRYL PDX-7630A, JONCRYL 352J, JONCRYL 352D, JONCRYL PDX-7145, JONCRYL 538J, JONCRYL 7640, JONCRYL 7641, JONCRYL 631, JONCRYL 790, JONCRYL 780, JONCRYL 7610 (trade names; manufactured by BASF Japan Ltd.).

The resin particles can be obtained in the following methods. Any of the methods can be used, and may be optionally used in combination thereof. Examples of the methods include a method of mixing a polymerization catalyst (polymerization initiator) and a dispersant into monomers having components of desired resin particles to be polymerized (that is, emulsion polymerization), a method of dissolving a resin which has a hydrophilic moiety into a water-soluble organic solvent, mixing the resulting solution into water, and removing the water-soluble organic solvent by distillation or the like to obtain the particles, and a method of dissolving a resin into a water-insoluble organic solvent and mixing the resulting solution and a dispersant into an aqueous solution to obtain the particles. The above-described methods can be appropriately selected according to the kind and characteristics of the resin used.

The dispersant which can be used when the resin is dispersed in the fine particle state is not particularly limited, and examples thereof include anionic surfactants (for example, sodium dodecylbenzenesulfonates, sodium laurates and ammonium polyoxyethylene alkyl ether sulfates) and nonionic surfactants (for example, polyoxyethylene alkyl ether, polyoxyethylene alkyl esters, polyoxyethylene sorbitan fatty acid esters, and polyoxyethylene alkyl phenyl ethers). The dispersant can be used alone or in a mixture of two or more kinds.

The average particle size of the resin particles is preferably 5 nm to 400 nm and more preferably 20 nm to 300 nm, from the viewpoint of securing the storage stability and discharge stability of the aqueous ink composition.

The content of the resin particles is, in terms of the solid content, equal to or less than 15% by mass and more preferably 0.2% by mass to 10% by mass, with respect to the total content of the aqueous ink composition. In the above-described range, the aqueous ink composition can be solidified and fixed even on the non-ink-absorbent or low-ink-absorbent recording medium.

The reason why the abrasion-resistance of printed matter is favorable when the above-described resin particles and the above-described waxes are used together, has not yet been made clear but is thought to be as follows.

The components of the resin particles have favorable affinity to the non-ink-absorbent or low-ink-absorbent recording medium and the water-insoluble colorant. Therefore, when a resin coating is formed during the heating process, the components are firmly fixed onto the recording medium while enclosing the colorant. Meanwhile, the components of the wax are present on the surface of the resin coating and have the characteristics of reducing the frictional resistance of the resin coating surface. In this way, the resin coating which is resistant to being scraped off by external abrasion and resistant to being peeled off from the recording medium can be formed. Therefore, the abrasion-resistance of printed matter is thought to be improved.

The ratio of the resin particles to the wax is preferably 10:3 to 10:32 resin particles:wax in terms of the solid content. In the above-described range, the above-described configuration favorably acts, thereby exhibiting favorable abrasion-resistance of printed matter. In addition, the total content of the resin particles and the wax is preferably 0.5% by mass to 6.5% by mass and more preferably 1% by mass to 5.5% by mass.

### 1.4.4 Nonionic Surfactants

The aqueous ink composition according to the invention preferably contains nonionic surfactants.

The nonionic surfactants have the action of uniformly spreading the aqueous ink composition on a recording medium. Therefore, the aqueous ink composition containing the nonionic surfactants has less uneven thickness and blurring and has the effect of obtaining clearer images. In addition, the nonionic surfactants are preferably used, but anionic or cationic surfactants may be used.

Examples of the nonionic surfactants having the above-described effect include polyoxyethylene alkyl ether-based, polyoxypropylene alkyl ether-based, polycyclic phenyl ether-based, sorbitan derivative-based, fluorine-based, silicone-based, and acetylene glycol-based surfactants.

Among these, the silicone surfactants and the acetylene glycol surfactants are preferable in terms of the excellent above-described effect and excellent compatibility and synergistic effect with the C5 to C7 1,2-alkyldiols which are preferably used in the aqueous ink composition according to the invention.

### 1.4.4.1 Silicone Surfactants

The aqueous ink composition according to the invention preferably contains the silicone surfactants. The silicone surfactants are superior to the other nonionic surfactants in terms of the action of uniformly spreading ink so as not to cause the uneven thickness and the blurring. In addition, the silicone surfactants have the excellent compatibility and the synergistic effect with the C5 to C7 1,2-alkyldiols which can be preferably added to the aqueous ink composition according to the invention.

The content of the silicone surfactants is preferably equal to or less than 1.5% by mass with respect to the total content of the aqueous ink composition. When the content of the silicone surfactants is more than 1.5% by mass, the storage stability and discharge stability of the aqueous ink composition may be not secured.

As the silicone surfactants, polysiloxane compounds are preferably used, and an example thereof includes polyether modified organosiloxane.

Specific examples thereof include BYK-306, BYK-307, BYK-333, BYK-341, BYK-345, BYK-346, BYK-348 (trade names; manufactured by BYK Japan KK) and KF-351A, KF-352A, KF-353, KF-354L, KF-355A, KF-615A, KF-945, KF-640, KF-642, KF-643, KF-6020, X-22-4515, KF-6011, KF-6012, KF-6015, KF-6017 (trade names; manufactured by Shin-Etsu Chemical Co., Ltd.).

### 1.4.4.2 Acetylene Glycol Surfactants

The aqueous ink composition according to the invention preferably contains the acetylene glycol surfactants.

The acetylene glycol surfactants are superior to the other nonionic surfactants in terms of the capability of appropriately maintaining the surface tension and the interfacial tension, and have almost no foaming property. In this way, the aqueous ink composition containing the acetylene glycol surfactants can appropriately maintain the surface tension and the interface tension with a printer member in contact with ink, such as a head nozzle surface. Therefore, when this composition is applied to the ink jet recording method, the discharge stability can increase. In addition, similar to the C5 to C7 1,2-alkyldiols, the acetylene glycol surfactants exhibit the favorable wettability and act as a good penetrant with respect to a recording medium. Therefore, high-definition images are printed by the aqueous ink composition containing the acetylene glycol surfactants with less uneven thickness and blurring. The content of the acetylene glycol surfactants is equal to or less than 1.0% by mass with respect to the total content of the aqueous ink composition. When the content of the acetylene glycol surfactants is more than 1.0% by mass, the storage stability and discharge stability of the aqueous ink composition may not be secured.

Examples of the acetylene glycol surfactants include SURFYNOL 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, DF110D (trade names; manufactured by Air Products and Chemicals. Inc.), ORPHIN B, Y, P, A, STG, SPC, E1004, E1010, PD-001, PD-002W, PD-003, PD-004, EXP.4001, EXP.4036, EXP.4051, AF-103, AF-104, AK-02, SK-14, AE-3 (trade names; manufactured by Nissin Chemical Industry CO., Ltd), and ACETYLENOL E00, E00P, E40, E100 (trade names; manufactured by Kawaken Fine Chemicals Co., Ltd.).

### 1.4.5 Pyrrolidone Derivatives

The aqueous ink composition according to the invention preferably contains pyrrolidone derivatives.

When acting as a good solubilizer or softener with respect to the resin particles, the pyrrolidone derivatives promote the coating formation using the resin particles at the time of ink drying and promote the fixing and solidifying of ink on the non-ink-absorbent or low-ink-absorbent recording medium. The content of the pyrrolidone derivatives is preferably 5% by mass to 25% by mass, preferably 13% by mass to 25% by mass, and further preferably 15% by mass to 20% by mass, with respect to the total content of the aqueous ink composition.

Examples of the pyrrolidone derivatives include low molecular weight compounds such as N-methyl-2-pyrrolidone, N-ethyl-2-pyrrolidone, N-vinyl-2-pyrrolidone, 2-pyrrolidone, N-butyl-2-pyrrolidone, and 5-methyl-2-pyrrolidone. Among these, 2-pyrrolidone, and N-methyl-2-pyrrolidone are preferable from the viewpoints of securing the storage stability of the aqueous ink composition, of promoting the coating formation of the resin particles, and of relatively less odor.

In addition, the ink composition is preferably used for recording on the non-ink-absorbent or low-ink-absorbent recording medium. Since the non-ink-absorbent or low-ink-absorbent recording medium has the characteristics that ink does not easily permeate, the attached ink may have a poor drying property. In this case, the ink composition improves the drying property when being attached onto the non-ink-absorbent or low-ink-absorbent recording medium. Therefore, it is preferable that an alkylpolyol with a boiling point under one atmosphere of 280° C. or more not be included in practice. Here, in this specification, “alkylpolyol is not included in practice” represents that, in ink, 0.1% by mass or more of an alkylpolyol is not included, more preferably 0.05% by mass or more of an alkylpolyol is not included, and further preferably 0.01% by mass or more of an alkylpolyol is not included. A typical example of the alkylpolyol with a boiling point of 280° C. or more under one atmosphere includes glycerin (boiling point: 290° C.)

### 1.5 Other Organic Solvent Components

The aqueous ink composition according to the invention may further contain a solvent having a moisturizing effect or a low surface tension. Examples thereof include water-soluble solvents such as ethylene glycol, diethylene glycol, triethylene glycol, propylene glycol, dipropylene glycol, 1,3-propanediol, 1,4-butanediol, 1,5-pentanediol, 1,6-hexanediol, ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxy butanol, propylene glycol monomethyl ether, propylene glycol monoethyl ether, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, dipropylene glycol mono-iso-propyl ether, diethylene glycol dimethyl ether, diethylene glycol diethyl ether, diethylene glycol dibutyl ether, diethylene glycol ethyl methyl ether, diethylene glycol butyl methyl ether, triethylene glycol dimethyl ether, tetraethylene glycol dimethyl ether, dipropylene glycol dimethyl ether, dipropylene glycol diethyl ether, tripropylene glycol dimethyl ether, methanol, ethanol, n-propyl alcohol, iso-propyl alcohol, 2,2-dimethyl-1-propanol, n-butanol, 2-butanol, tert-butanol, iso-butanol, 2-methyl-1-butanol, 3-methyl-1-butanol, 3-methyl-2-butanol, n-pentanol, 2-pentanol, 3-pentanol, and tert-pentanol.

### 1.6 Other Added Components

In addition to the above-described preferable components, in order to improve the characteristics thereof, a pH adjuster, a preservative or fungicide, a rust inhibitor, a chelator and the like can be added to the aqueous ink composition according to the invention.

Examples of the pH adjuster include potassium dihydrogen phosphate, disodium hydrogen phosphate, sodium hydroxide, lithium hydroxide, potassium hydroxide, ammonia, diethanolamine, triethanolamine, triisopropanolamine, potassium carbonate, sodium carbonate, and sodium bicarbonate.

Examples of the preservative or fungicide include sodium bicarbonate, sodium pentachlorophenol, sodium 2-pyridinethiol-1-oxide, sodium sorbate, sodium dehydroacetate, and 1,2-benzisothiazolin-3-one. Examples of commercially available products thereof include PROXEL XL2, PROXEL GXL (trade names; manufactured by Avecia Investments Limited) and DENICIDE CSA, NS-500W (trade names; manufactured by Nagase ChemteX Corporation).

An example of the rust inhibitor includes benzotriazole.

Examples of the chelator include ethylenediaminetetraacetic acid and the salts thereof (dihydrogen disodium ethylenediaminetetraacetate).

### 1.7 Physical Properties of Aqueous Ink Composition

The viscosity of the aqueous ink composition is preferably 1.5 mPa·s to 15 mPa·s at 20° C. In the above-described range, the discharge stability of ink from the discharge head can be secured. The viscosity of the aqueous ink composition can be measured by a vibration-type viscometer VM-100AL (manufactured by Yamaichi Electronics Co., Ltd.) while maintaining the temperature of the aqueous ink composition at 20° C.

The surface tension of the aqueous ink composition is preferably 20 mN/m to 40 mN/m and more preferably 25 mN/m to 35 mN/m at 25° C. In the above-described range, the discharge stability of ink from the discharge head can be secured and an appropriate wettability to the non-ink-absorbent or low-ink-absorbent recording medium can be secured. The surface tension of the aqueous ink composition can be measured by a surface tensiometer CBVP-Z (manufactured by Kyowa Interface Science Co., LTD.).

### 1.8 Production Method of Aqueous Ink Composition

The aqueous ink composition according to the invention can be obtained by mixing the above-described materials in an arbitrary order and, optionally, by removing impurities by filtration or the like. Here, for handleability, the colorant is preferably mixed in a state of being uniformly dispersed in an aqueous medium in advance.

As a method of mixing each of the materials, a method in which the materials are sequentially added to a container having a stirring device such as a mechanical stirrer or a magnetic stirrer to be mixed and stirred, is preferably used. As a filtration method, a centrifugal filtration and a filter filtration can be used.

### 2. Ink Jet Recording Method

Next, each of processes of the ink jet recording method according to the invention will be described in detail. In the ink jet recording method according to the invention, the ink composition is discharged on a plain paper, a sheet for ink jet recording (matte paper or glossy paper), a book printing paper, a synthetic paper, a film, a plastic, a fabric, or the like. It is preferable that the heating process of heating images, which are formed by discharging dropwise the above-described aqueous ink composition onto a recording medium, be added. In addition, when the heating process (mechanism) is added, the non-ink-absorbent or low-ink-absorbent recording medium is preferably used. Here, in the present specification, “non-ink-absorbent or low-ink-absorbent recording medium” represents “a recording medium in which the amount of absorbing water until 30 msec^{1/2} from the contact is equal to or less than 10 mL/m² in the Bristow's method. This Bristow's method is most widely used as a method of measuring a liquid absorption amount in a short period of time, and is employed by the Japan Technical Association of the Pulp and Paper Industry (JAPAN TAPPI). The details of the test method is described in “JAPAN TAPPI pulp and paper testing method No. 51, 2000; Paper and board-Liquid absorbability test method-Bristow's method”.

### 2.1 Heating Process (Mechanism)

The ink composition according to the invention preferably contains the heating process. In the heating process, the aqueous ink composition is discharged dropwise onto a recording medium which is heated in the range of 40° C. to 110° C. by a printer heater provided to an ink jet recording apparatus. In particular, the heating process promotes the evaporation of water and the fixing of the wax and the resin particles in combination with the non-ink-absorbent or low-ink-absorbent recording medium, thereby exhibiting a more favorable effect. In addition, the heating temperature is a temperature of a recording medium surface in contact with the ink composition. At this time, when the heating process is performed in two stages, it is preferable that the heating temperature be appropriately adjusted according to the heat-resistance of the recording medium in the temperature range of 40° C. to 80° C. in a first heating process and in the temperature range of 50° C. to 110° C. in a second heating process. In addition, it is preferable that heating be performed while recording images onto the recording medium in the first heating process and be performed after the recording in the second heating process. In addition, it is preferable that the heating temperature in the second heating process be higher than that in the first heating process.

The heating process is not particularly limited as long as a method of promoting a liquid medium present in the aqueous ink composition to be evaporated and scattered is used. Examples of the method include a method of heating a recording medium, a method of blowing air into the aqueous ink composition on the recording medium, and a combination thereof. Specifically, heating by warm air or a heater such as forced-air heating, radiation heating, conduction heating, high-frequency drying, and microwave drying is preferably used.

### 2.2 Discharge Head

Examples of the method of discharging the ink composition include known discharge methods such as a piezoelectric element method, a thermal jet method, and an electrostatic attraction method. Among these, the invention is preferably applied to the piezoelectric element method. When the piezoelectric element method is used, the ink composition is discharged according to the deflection amount of the piezoelectric element and a liquid drop amount is freely adjustable. Therefore, high-color images are suitably recorded by this method. When the liquid drop amount is freely adjusted, the liquid drop amount is easily affected by the effect of drying and solidifying of the ink composition around a nozzle. The paraffin wax having the excellent anti-clogging property is suitable for this method. Furthermore, the method is further effective in combination with the ink composition which does not contain the alkylpolyol with a boiling point under one atmosphere of 280° C. or more in practice.

A nozzle diameter of the discharge head is not particularly limited, but preferably 5 μm to 35 μm and more preferably 10 μm to 30 μm. When the nozzle diameter is in the above-described range, regions around the nozzle are prevented from being dried and an appropriate liquid drop amount can be secured in the case of being recorded by the ink jet recording method.

### EXAMPLES

Hereinafter, the invention will be described in detail with reference to Examples, but is not limited to thereto.

### 1. Preparation of Pigment Dispersion Liquid

In the aqueous ink composition used in the present example, the water-insoluble pigment was used as the colorant. When the pigment was added to the aqueous ink composition, the resin dispersion pigment in which the pigment was dispersed in the resin dispersant in advance was used. The pigment dispersed material was prepared as follows.

40 parts by mass of high molecular weight dispersants (which were copolymerized with the mass ratio of methacrylic acid:butyl acrylate:styrene:hydroxyethyl acrylate=25:50:15:10; weight-average molecular weight of 12000) were added to a mixture of 7 parts by mass of potassium hydroxide, 23 parts by mass of water, and 30 parts by mass of triethylene glycol-mono-n-butyl ether, followed by heating and stirring at 80° C. and carrying out polymerization reaction to prepare a high molecular weight varnish.

33.0 kg of C.I. PIGMENT BLUE 15 as the cyan pigment, 1.5 kg of ethylene glycol, and 8.1 kg of water were blended into 2.4 kg of the varnish (solid content of 43%), followed by stirring by a mixer to be premixed. This pigment dispersion mixture was dispersed in a multi-pass method by a horizontal bead mill which was filled with 0.5 mm of zirconia beads to 85% and was provided with a multi-disk impeller having an effective volume of 1.5 liters. Specifically, two-pass dispersion was carried out for one hour under the conditions of the bead circumferential speed of 8 m/sec and the discharge amount of 30 liters to obtain the pigment dispersion mixture with the average particle size of 325 nm. Next, circulating dispersion was performed by a horizontal annular bead mill which was filled with 0.05 mm of zirconia to 95% and had an effective volume of 1.5 liters. 10 kg of pigment dispersion mixture was dispersed for four hours using a 0.015 mm-length screen under the conditions of a bead circumferential speed of 10 m/sec and a circulating load of 300 liters/hour to obtain a cyan pigment dispersion liquid.

### 2. Preparation of Aqueous Pigment Ink

Using the cyan pigment dispersion liquid prepared in “1.” above, aqueous pigment ink was prepared with the material composition shown in Table 1.

Materials shown in Table 1 were put into a container and stirred and mixed by a magnetic stirrer for two hours, followed by filtration with a 5 μm membrane filter and removal of impurities such as dust and coarse particles to obtain each of aqueous ink compositions. Numerical values in Table 1 represent % by mass and ion exchange water was added such that the total amount of ink became 100% by mass.

TABLE 1

| | | Example | Example | Example | Comparative | Comparative | Comparative | Comparative |
|---|---|---|---|---|---|---|---|---|
| Composition | Remarks | 1 | 2 | 3 | Example 1 | Example 2 | Example 3 | Example 4 |
| Pigment | | 4 | 4 | 4 | 4 | 4 | 4 | 4 |
| (Solid Content) | | | | | | | | |
| 1,2-Hexanediol | | 4 | 4 | 4 | 4 | 4 | 4 | 4 |
| 2-Pyrrolidone | | 15 | 15 | 15 | 15 | 15 | 15 | 15 |
| Silicone | BYK-348 | 0.5 | 0.5 | 0.5 | 0.5 | 0.5 | 0.5 | 0.5 |
| Surfactant | | | | | | | | |
| Water-Soluble | Styrene-Acrylic Acid | 1 | 1 | 1 | 1 | 1 | 1 | 1 |
| Resin | Copolymer | | | | | | | |
| (Solid Content) | | | | | | | | |
| Resin Particles | Resin Emulsion, Styrene- | 1.5 | 1.5 | 1.5 | 1.5 | 1.5 | 1.5 | 1.5 |
| (Solid Content) | Acrylic Acid Copolymer | | | | | | | |
| Paraffin Wax | AQ539 | 1 | — | — | — | — | — | — |
| (Solid Content) | CEROSOL H-620 | — | 1 | — | — | — | — | — |
| | AQ537 | — | — | 1 | — | — | — | — |
| | AQ498 | — | — | — | 1 | — | — | — |
| | CEROSOL 686 | — | — | — | — | 1 | — | — |
| | CEROSOL E-172 | — | — | — | — | — | 1 | — |
| Polyethylene | AQUACER 515 | 0.2 | 0.2 | 0.2 | 0.2 | 0.2 | 0.2 | 1 |
| Wax | | | | | | | | |
| (Solid Content) | | | | | | | | |

| | |
|---|---|
| Pure Water | Added such that the sum total in vertical columns is 100 |

### 3. Evaluation Test of Aqueous Cyan Pigment Ink Evaluation Method

A printer using a piezoelectric element PX-G930 (manufactured by Seiko Epson Corp.; nozzle diameter: 20 μm) was partially converted to manufacture a printer which could adjust heating of a recording medium during recording. Using this printer, the following evaluation of ink according to Examples and Comparative examples above was performed. In addition, for the following evaluations of all the samples, ink jet recording was performed with the resolution of 720 dpi×720 dpi.

### 1. Anti-Clogging Property

It was confirmed that the printer PX-G930 was filled with ink and normally operated. Next, the power was turned off, followed by being left to stand for 24 hours at 40° C. After returning the temperature to room temperature, the power was turned on to perform the recording and then the state was checked.

### Evaluation Criteria

◯: When the power was turned on, recording was normally performed.
Δ: Curving partially occurred first, but recording became normal as the recording continued.
x: Curving occurred and recording was not performed normally.

### 2. Storage Stability

30 g of each ink was put into a sample glass bottle. Then, the bottle was closed with a lid and left to stand for five days at 60° C. Before and after being left to stand, the viscosity of the ink was measured.

Viscometer: vibration-type viscometer VM-100AL (manufactured by Yamaichi Electronics Co., Ltd.), Measurement temperature: 20° C.

### Evaluation Criteria

◯: There was no change in viscosity.
Δ: There was a small increase in viscosity.

### 3. Quick-Drying Property

The following recording medium was heated to 45° C. during recording and, after the recording, dried for one minute at 60° C. Then, the dried state of the ink was evaluated on the basis of the state when a finger touched the medium after the printing.

Recording medium: Polyvinyl chloride (PVC) film LLSP EX113 (manufactured by SAKURAI CO., LTD.), Printed pattern: 50% duty solid

### Evaluation Criteria

◯: There was no ink transfer to the finger
x: There was ink transfer to the finger

### 4. Ink Uniformity

30 g of each ink was put into a sample glass bottle. Then, the bottle was closed with a lid and left to stand for a week at room temperature. After a week, the lid was opened and visual inspection was performed as to whether or not there were separated substances.

### Evaluation Criteria

◯: There were no separated substances and ink was uniformly dispersed.
x: There were separated substances on the surface.

### 5. Abrasion-Resistance

The following recording medium was heated to 45° C. during recording and, after the recording, dried for one minute at 60° C. Then, the abrasion of the recording medium left to stand for 16 hours at room temperature was evaluated. Using a JSPS (Japan Society for the Promotion of Science) type color fastness rubbing tester, visual inspection was performed as to whether or not there was abrasion on the recording surface when the recorded matter was rubbed 50 times by a cotton fabric under the load of 500 g.

Recording medium: Polyvinyl chloride (PVC) film LLSP EX113 (manufactured by SAKURAI CO., LTD.)

### Evaluation Criteria

◯: Abrasion was not recognized.
Δ: A little abrasion was recognized.

The results are shown in Table 2.

TABLE 2

| | | Product | | | Melting | Particle | Anti- | | Quick- | Ink | |
|---|---|---|---|---|---|---|---|---|---|---|---|
| | | Name of | Kind of | | Point | Size | Clogging | Storage | Drying | Uni- | Abrasion- |
| | | Wax | Wax | Manufacturer | (° C.) | (nm) | Property | Stability | Property | formity | Resistance |
| Examples | Example 1 | AQUACER | Paraffin | BYK Japan KK | 90 | 54 | ∘ | ∘ | ∘ | ∘ | ∘ |
| | | 539 | | | | | | | | | |
| | Example 2 | CEROSOL | Paraffin | CHUKYO YUSHI | 68 | 200 | ∘ | ∘ | ∘ | ∘ | ∘ |
| | | H-620 | | CO., LTD. | | | | | | | |
| | Example 3 | AQUACER | Paraffin | BYK Japan KK | 110 | 33 | ∘ | Δ | ∘ | ∘ | ∘ |
| | | 537 | | | | | | | | | |
| Comparative | Comparative | AQUACER | Paraffin | BYK Japan KK | 60 | 370 | ∘ | ∘ | ∘ | x | Δ |
| Examples | Example 1 | 498 | | | | | | | | | |
| | Comparative | CEROSOL | Paraffin | CHUKYO YUSHI | 54 | 500 | Δ | ∘ | x | x | Δ |
| | Example 2 | 686 | | CO., LTD. | | | | | | | |
| | Comparative | CEROSOL | Paraffin | CHUKYO YUSHI | 68 | 500 | Δ | ∘ | ∘ | x | ∘ |
| | Example 3 | E-172 | | CO., LTD. | | | | | | | |
| | Comparative | AQUACER | Poly- | BYK Japan KK | 135 | 60 | x | ∘ | ∘ | ∘ | ∘ |
| | Example 4 | 515 | ethylene | | | | | | | | |

It can seen from Table 2 that the paraffin waxes with a melting point of 60° C. to 110° C. and an average particle size of 30 nm to 200 nm are practical in terms of all the items of anti-clogging property, storage stability, quick-drying property, ink uniformity, and abrasion-resistance.

What is claimed is:

1. An aqueous ink composition comprising:
at least one kind of water-insoluble colorant; and
a wax,
wherein the wax is a paraffin wax with a melting point of 60° C. to 110° C. and an average particle size of 30 nm to 250 nm.

2. The ink composition according to claim 1,
wherein the content of the paraffin wax is 0.1% by mass to 3% by mass.

3. The ink composition according to claim 1,
wherein the average particle size of the paraffin wax is 50 nm to 200 nm.

4. The ink composition according to claim 1,
wherein the melting point of the paraffin wax is 65° C. to 100° C.

5. The ink composition according to claim 1,
wherein an alkylpolyol with a boiling point of 280° C. or higher under one atmosphere is not included in practice.

6. The ink composition according to claim 1, further comprising resin particles,
wherein the total content of the resin particles and the wax is 1% by mass to 5.5% by mass.

7. The ink composition according to claim 1, further comprising a 1,2-alkyldiol having 5 to 7 carbon atoms, resin particles, nonionic surfactants, and pyrrolidone derivatives.

8. The ink composition according to claim 1,
wherein the ink composition is discharged from a discharge head through a nozzle having the diameter of 10 μm to 30 μm.

9. The ink composition according to claim 1,
wherein the ink composition is discharged from a discharge head having a piezoelectric element.

10. The ink composition according to claim 1,
wherein the ink composition is discharged onto a recording medium which is heated by a heating mechanism.
